(19) United States
(12) Patent Application Publication
(10) Pub. No.: US 2019/0106210 A1
(43) Pub. Date: Apr. 11, 2019

(54) UNMANNED AERIAL VEHICLES WITH TILTING PROPELLERS, AND ASSOCIATED SYSTEMS AND METHODS

(71) Applicant: SZ DJI TECHNOLOGY CO., LTD., Shenzhen (CN)

(72) Inventor: Zongyao QU, Shenzhen (CN)

(21) Appl. No.: 16/214,714

(22) Filed: Dec. 10, 2018

Related U.S. Application Data
(63) Continuation of application No. PCT/CN2016/086624, filed on Jun. 21, 2016.

(51) Int. Cl. B64C 27/52; B64C 27/37; B64C 27/20; B64C 39/02; H02N 2/10

(52) U.S. Cl. CPC B64C 27/52; B64C 27/37; B64C 27/20; B64C 2201/108; H02N 2/108; B64C 2201/027; B64C 2201/042; B64C 39/024

(57) ABSTRACT

An unmanned aerial vehicle (UAV) apparatus includes an airframe, a plurality of spherical motors carried by the airframe, and a plurality of rotatable propellers each being carried by one of the spherical motors.

### CROSS-REFERENCE TO RELATED APPLICATION

This application is a continuation of International Application No. PCT/CN2016/086624, filed on Jun. 21, 2016, the entire contents of which are incorporated herein by reference.

### TECHNICAL FIELD

The present technology is directed generally to unmanned aerial vehicles with tilting propellers, and associated systems and methods.

### BACKGROUND

Unmanned aerial vehicles (UAVs) can operate autonomously, or under the control of an off-board human controller. Accordingly, UAVs can perform a wide variety of missions that are dangerous, expensive, and/or otherwise objectionable for performance by a manned aircraft. Representative missions include crop surveillance, real estate photography, inspection of buildings and other structures, fire and safety missions, border patrols, and product delivery, among others. A representative mission includes obtaining images via a camera or other image sensor carried by the UAV. A challenge with obtaining such images with a UAV is that, because the UAV is airborne, it can be difficult to stabilize the image under at least some conditions, including conditions during which the UAV undergoes maneuvers. Accordingly, there remains a need for improved techniques and systems for controlling UAVs and the payloads carried by the UAVs.

### SUMMARY

The following summary is provided for the convenience of the reader and identifies several representative embodiments of the disclosed technology.

An unmanned aerial vehicle (UAV) apparatus in accordance with a representative embodiment includes an airframe, a plurality of spherical motors carried by the airframe, and a plurality of rotatable propellers, with individual propellers carried by corresponding individual spherical motors. In particular embodiments, at least one of the individual spherical motors can include a rotor and at least one stator, with at least one of the rotor and the at least one stator rotatable relative to the other about two, or three intersecting axis. The intersecting axes can be orthogonal in particular embodiments. In any of the foregoing embodiments, an individual spherical motor can include a rotor and three stators, and/or can include an ultrasonic spherical motor. In any of the foregoing embodiments, the spherical motor can include a plurality of stators having fixed positions relative to the airframe, and a rotor carrying the corresponding individual propeller, and being rotatable relative to the plurality of stators. The rotor can include a propeller shaft having a shaft axis and carrying the corresponding individual propeller, and rotation of the rotor about the shaft axis rotates the propeller about the shaft axis. In any of the foregoing embodiments, the rotor can carry an electric motor having a propeller shaft carrying the corresponding individual propeller, wherein activation of the electric motor rotates the propeller shaft and the propeller about the shaft axis. For example, the electric motor can include a brushless direct current motor. In another representative embodiment, the rotor can have a fixed position relative to the airframe, and the stators can carry the individual propeller, and can be rotatable as a unit relative to the rotor.

In any of the foregoing embodiments, the airframe can include a central portion and at least three outer portions positioned outwardly from the central portion. For example, each individual outer portion can carry a single propeller and in particular embodiments, each outer portion can include an arm, at least a portion of which is separated from neighboring arms. In any of the foregoing embodiments, the apparatus can further comprise an imaging device carried by the airframe. The imaging device can include a camera, and in particular embodiments, the apparatus can further include a gimbal coupled between the airframe and the imaging device.

In any of the foregoing embodiments, the apparatus can further comprise a controller programmed with instructions for controlling the UAV. For example, representative instructions, when executed, receive a request to change a direction of travel of the airframe and, in response to the request, direct at least one of the plurality of spherical motors to tilt the corresponding individual propeller. In any of the foregoing embodiments, the instructions, when executed, can direct the at least one spherical motor to tilt the corresponding individual propeller, without directing the airframe to tilt. In particular embodiments, the instructions can direct a first propeller to tilt in a first direction, and direct a second propeller to tilt in a second direction opposite the first direction. In still further embodiments, the instructions can direct the at least one spherical motor to tilt the corresponding individual propeller without changing an orientation of an imaging device carried by the UAV. In still a further particular embodiment, the instructions can direct the at least one spherical motor to tilt without causing the imaging device to image (e.g., capture an image of) the airframe. The instructions can direct at least one spherical motor to tilt a thrust axis of the corresponding propeller outwardly away from the airframe, e.g., to avoid or reduce the extent to which air driven by the propeller impinges upon the airframe.

In any of the foregoing embodiments, the controller can include a first controller carried by the airframe and having a first wireless communication device, and the apparatus can further comprise a remote second controller having a second wireless communication device configured to communicate wirelessly with the first wireless communication device.

In other embodiments, a propulsion apparatus for an unmanned aerial vehicle includes a spherical motor having a rotor and a plurality of stators shaped to be in rotational contact with the rotor. A shaft is carried by the rotor or at least one of the stators, and a propeller is carried by the shaft. The arrangement of the rotor, stators, and propeller can have any of the configurations described above.

In still further embodiments, an unmanned aerial vehicle control apparatus can include a controller and a computer-readable medium carried by the controller and programmed with instructions that, when executed receive a request to change a direction of travel of the UAV, and, in response to the request, direct at least one of a plurality of spherical motors to tilt a corresponding propeller of the UAV. The instructions, when executed can direct the spherical motor to operate in any of the manners described above.

Still a further embodiment includes a method for configuring a UAV controller, comprising programming a computer-readable medium with instructions that, when executed receive a request to change a direction of travel of the UAV and, in response to the request, direct at least one of a plurality of spherical motors to tilt a corresponding propeller of the UAV. The instructions can direct the spherical motor to operate in any of the manners described above.

Still a further embodiment includes computer-implemented method for flying an unmanned aerial vehicle, comprising receiving a request to change a direction of travel of the UAV, and in response to the request, directing at least one of a plurality of spherical motors to tilt a corresponding propeller of the UAV. The computer-implemented method can direct the spherical motor to operate in any of the manners described above.

### BRIEF DESCRIPTION OF THE DRAWINGS

FIG. 1 is a schematic illustration of a UAV having spherical motors positioned to control multiple propellers, in accordance with a representative embodiment of the present technology.

FIG. 2 is a schematic, enlarged view of a representative spherical motor configured to rotate a propeller about multiple axes, in accordance with representative embodiments of the present technology.

FIG. 3A is a schematic side view illustration of a UAV carrying multiple spherical motors in accordance with embodiments of the present technology.

FIG. 3B is a schematic illustration of a controller carried onboard a UAV and configured to control the UAV in accordance with representative embodiments of the present technology.

FIG. 4 is a schematic illustration of the UAV shown in FIG. 3A, with multiple propellers tilted in the same direction, in accordance with an embodiment of the present technology.

FIG. 5 is a schematic illustration of the UAV shown in FIG. 3A, with multiple propellers tilted in opposite directions in accordance with an embodiment of the present technology.

FIG. 6 is a schematic illustration of a UAV carrying a spherical motor having a fixed rotor and rotatable stators in accordance with an embodiment of the present technology.

FIG. 7 is a schematic illustration of a spherical motor carrying an electrically driven propeller motor in accordance with an embodiment of the present technology.

FIG. 8 is a flow diagram illustrating processes for controlling a UAV in accordance with representative embodiments of the present technology.

### DETAILED DESCRIPTION

### 1. Overview

The present technology is directed generally to unmanned aerial vehicles (UAVs) with tilting propellers, and associated systems and methods. In particular embodiments, the UAVs include spherical motors that support one or more rotating propellers. The spherical motors can be used to tilt the propeller shafts without tilting the airframe of the UAV. The propeller shafts themselves can be driven by the spherical motor, or by an additional propeller motor carried by one or more components of the spherical motor. This arrangement is expected to provide several advantages when compared to conventional UAV propulsion systems, as will be described further below.

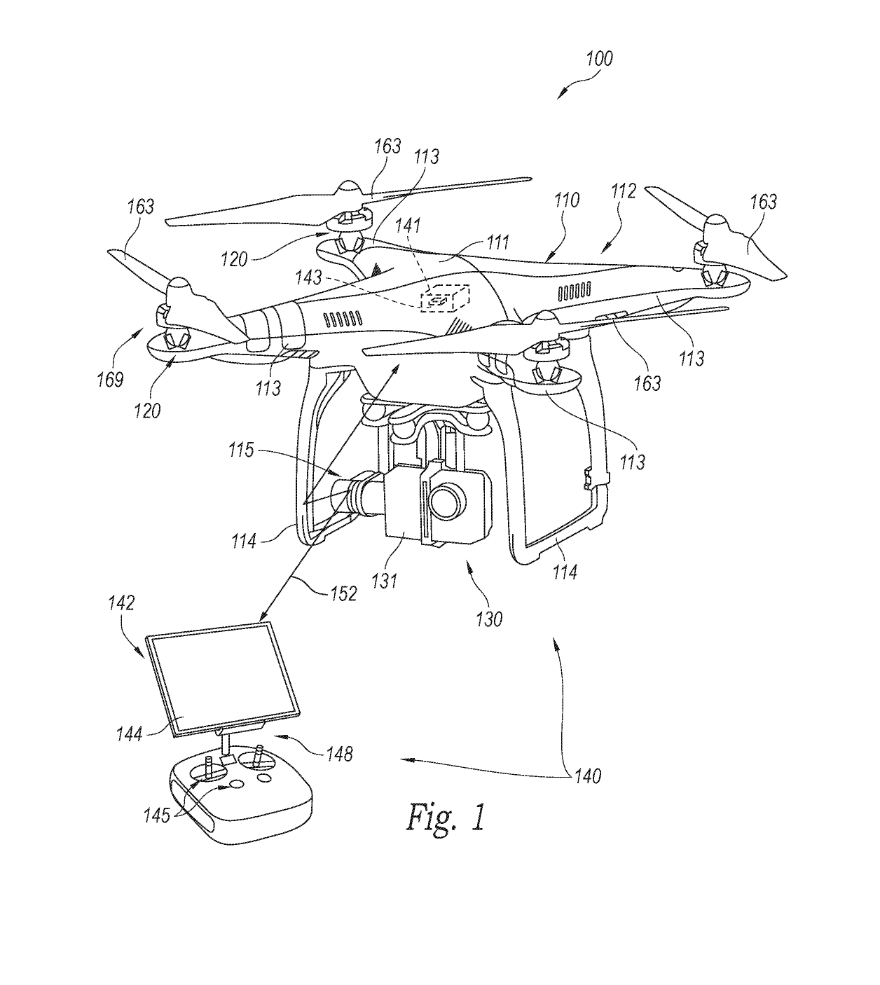

Several details describing structures or processes that are well-known and often associated with UAVs and corresponding systems and subsystems, but that may unnecessarily obscure some significant aspects of the disclosed technology, are not set forth in the following description for purposes of clarity. Moreover, although the following disclosure sets forth several embodiments of different aspects of the technology, several other embodiments can have different configurations or different components than those described in this section. Accordingly, the technology may have other embodiments with additional elements and/or without several of the elements described below with reference to FIGS. 1-8.

FIGS. 1-8 are provided to illustrate representative embodiments of the disclosed technology. Unless provided for otherwise, the drawings are not intended to limit the scope of the claims in the present application.

Many embodiments of the technology described below may take the form of computer- or controller-executable instructions, including routines executed by a programmable computer or controller. Those skilled in the relevant art will appreciate that the technology can be practiced on computer or controller systems other than those shown and described below. The technology can be embodied in a special-purpose computer or data processor that is specifically programmed, configured or constructed to perform one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, mini computers and the like). Information handled by these computers and controllers can be presented at any suitable display medium, including a CRT display or LCD. Instructions for performing computer- or controller-executable tasks can be stored in or on any suitable computer-readable medium, including hardware, firmware or a combination of hardware and firmware. Instructions can be contained in any suitable memory device, including, for example, a flash drive, USB device, and/or other suitable medium.

### 2. Representative Embodiments

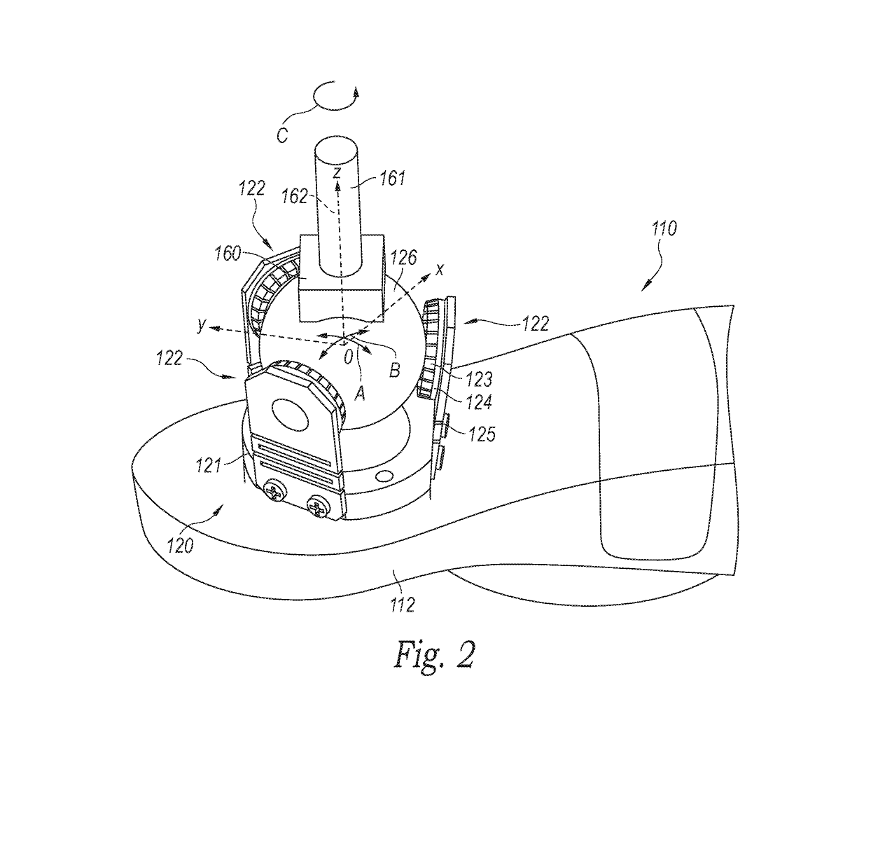

FIG. 1 is a schematic, illustration of a representative UAV 100 configured in accordance with embodiments of the present technology. The UAV 100 can include an airframe 110 that in turn can include a central portion 111 and one or more outer portions 112. In a representative embodiment shown in FIG. 1, the airframe 110 includes four outer portions 112 (e.g., arms 113) that are spaced apart from each other as they extend away from the central portion 111. In other embodiments, the airframe 110 can include other numbers of outer portions 112. In any of these embodiments, individual outer portions 112 can support components of a propulsion system 169 that drives the UAV 100. For example, individual arms 113 can support corresponding individual propellers 163. The propellers 163 can in turn be driven by spherical motors 120 that allow the propellers to be tilted relative to the airframe 110, as will be described further later with reference to FIGS. 2-8.

The airframe 110 can carry a payload 130, for example, an imaging device 131. In particular embodiments, the imaging device 131 can include a camera, for example, a video camera and/or still camera. The camera can be sensitive to wavelengths in any of a variety of suitable bands, including visual, ultraviolet, infrared and/or other bands. In still further embodiments, the payload 130 can include other types of sensors and/or other types of cargo (e.g., packages or other deliverables). In many of these embodiments, the payload 130 is supported relative to the airframe 110 with a gimbal 115 that allows the payload 130 to be independently positioned relative to the airframe 110. Accordingly, for example when the payload 130 includes the imaging device 131, the imaging device 131 can be moved relative to the airframe 110 to track a target. When the UAV 100 is not in flight, landing gear 114 can support the UAV 100 in a position that protects the payload 130, as shown in FIG. 1.

In a representative embodiment, the UAV 100 includes a control system 140 having some components carried on the UAV 100 and some components positioned off the UAV 100. For example, the control system 140 can include a first controller 141 carried by the UAV 100 and a second controller 142 (e.g., a human-operated, ground-based controller) positioned remote from the UAV 100 and connected via a communication link 152 (e.g., a wireless link). The first controller 141 can include a computer-readable medium 143 that executes instructions directing the actions of the UAV 100, including, but not limited to, operation of the propulsion system 169 and the imaging device 131. The second controller 142 can include one or more input/output devices 148, e.g., a display 144 and control devices 145. The operator manipulates the control devices 145 to control the UAV 100 remotely, and receives feedback from the UAV 100 via the display 144 and/or other devices. In other representative embodiments, the UAV 100 can operate autonomously, in which case the second controller 142 can be eliminated, or can be used solely for operator override functions. In any of these embodiments, the control system 140 directs the operation of the spherical motors 120, which are described in further detail below.

FIG. 2 is a schematic, enlarged view of a portion of the airframe 110 shown in FIG. 1, illustrating a representative spherical motor 120 configured in accordance with a representative embodiment of the present technology. In a particular aspect of this embodiment, the spherical motor 120 can include an ultrasonic motor with three degrees of freedom. Representative motors are available from OK Robotics (www.ok-robotics.com). The general operation of ultrasonic spherical motors is described in an article titled “Design and Implementation of Spherical Ultrasonic Motor,” Mashimo et. al, IEEE Transactions on Ultrasonics, Ferroelectrics, and Frequency Control, vol. 56, No. 11 (November, 2009), incorporated herein by reference.

The spherical motor 120 can include a spherical or partially spherical rotor 126 supported relative to the airframe 110 with multiple stators 122. For example, FIG. 2 illustrates three stators 122 in contact with the rotor 126. Each stator 122 can include a piezoelectric member 123 that contacts the rotor 126, an electrode 124 that provides electrical signals to the piezoelectric member 123, and a stator support 125 that carries the electrode 124 and the piezoelectric member 123. Each stator support 125 can be carried by a mounting element 121, which is in turn attached to the airframe 110.

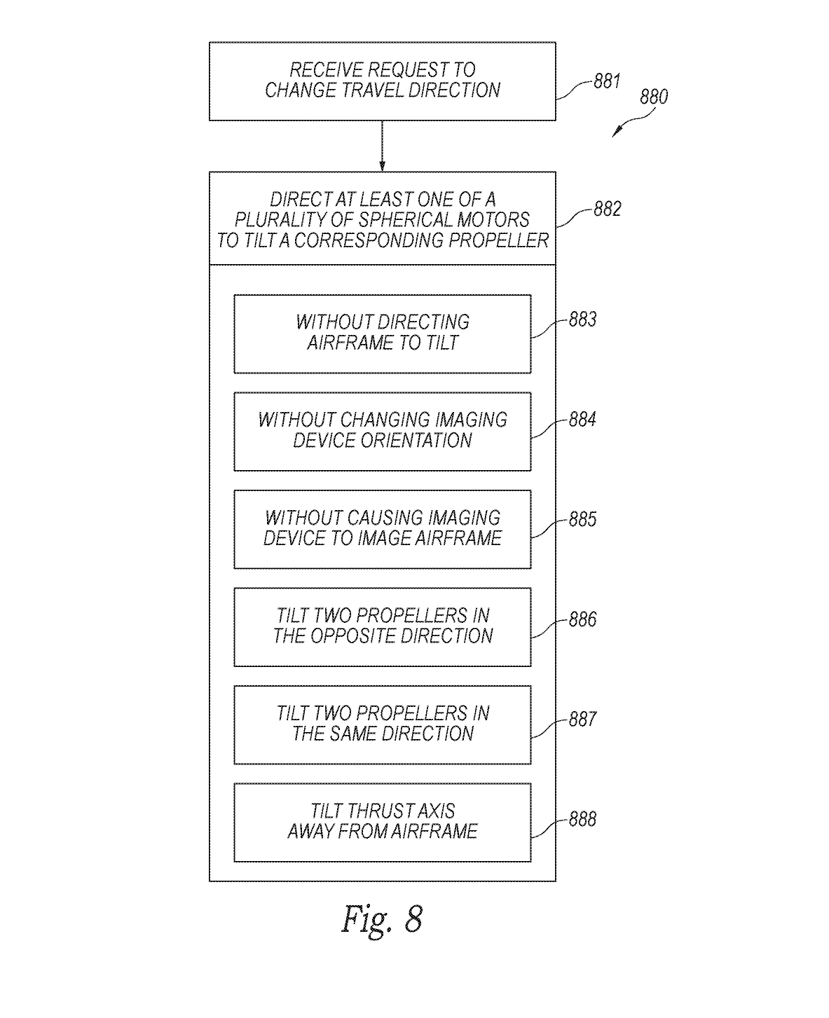

As the stators 122 (in particular, the piezoelectric members 123) are actuated, the rotor 126 can be directed to rotate about any of the illustrated x, y, or z axes. The intersecting x, y and z axes can be orthogonal (as shown in FIG. 2) or can have other relative orientations in other embodiments. The rotor 126 can tilt relative to the x axis as indicated by arrow A, relative to the y axis as indicated by arrow B, and relative to the z axis as indicated by arrow C. In the illustrated embodiment, the rotor 126 carries a propeller motor 160 that in turn drives a propeller shaft 161 to spin about a shaft axis 162. As shown in FIG. 2, the shaft axis 162 coincides with the z axis. The propeller shaft 161 carries a corresponding propeller 163 (shown in FIG. 1). Accordingly, the stators 122 can be selectively activated to tilt the propeller shaft 161 relative to the x and y axes, as the propeller motor 160 spins the propeller shaft 161 about the shaft axis 162. Further details of a representative propeller motor 160 are described later with reference to FIG. 8. In another embodiment, the propeller shaft 161 can be coupled or connected directly to the rotor 126, without including a propeller motor 160. Accordingly, the stators 122 can be selectively activated to spin the propeller shaft 161 about the shaft axis 162, in addition to tilting the propeller shaft 161 about the x and y axes.

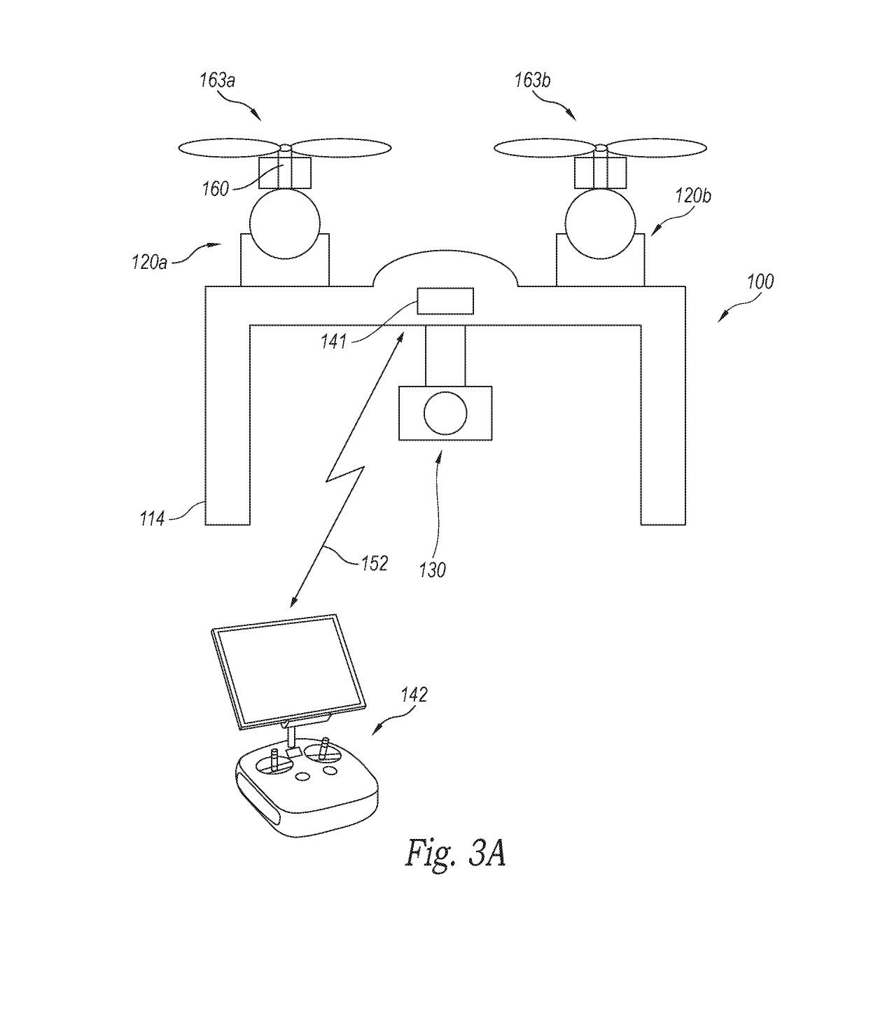

FIGS. 3A-5 schematically illustrate the UAV 100 as it undergoes multiple maneuvers in accordance with the present technology. FIG. 3A illustrates the UAV 100 with two representative spherical motors 120a, 120b and corresponding propellers 163a, 163b visible. In a typical embodiment, as described above, the UAV 100 will include more than two spherical motors 120 and corresponding propellers 163, e.g., three or four spherical motors. The first controller 141, under the direction of the second controller 142, has positioned the propellers 163a, 163b for hovering. In particular, the propellers 163a, 163b are both positioned to face directly upwards.

FIG. 3B is a schematic illustration of the first controller 141, which can include a processor 146, memory 147, and input/output devices 148. The memory 147 can be removable from the first controller 141, e.g., separable from the input/output devices 148. A control unit 151 directs the operation of the spherical motors described above, and a computer readable medium 143 (which can be housed in and/or include components of any of the foregoing components) contains instructions that, when executed, direct the behavior of the spherical motors. A first communication device 150a is configured to provide wireless communication with a corresponding second communication device 150b carried by the second controller 142, via the communication link 152.

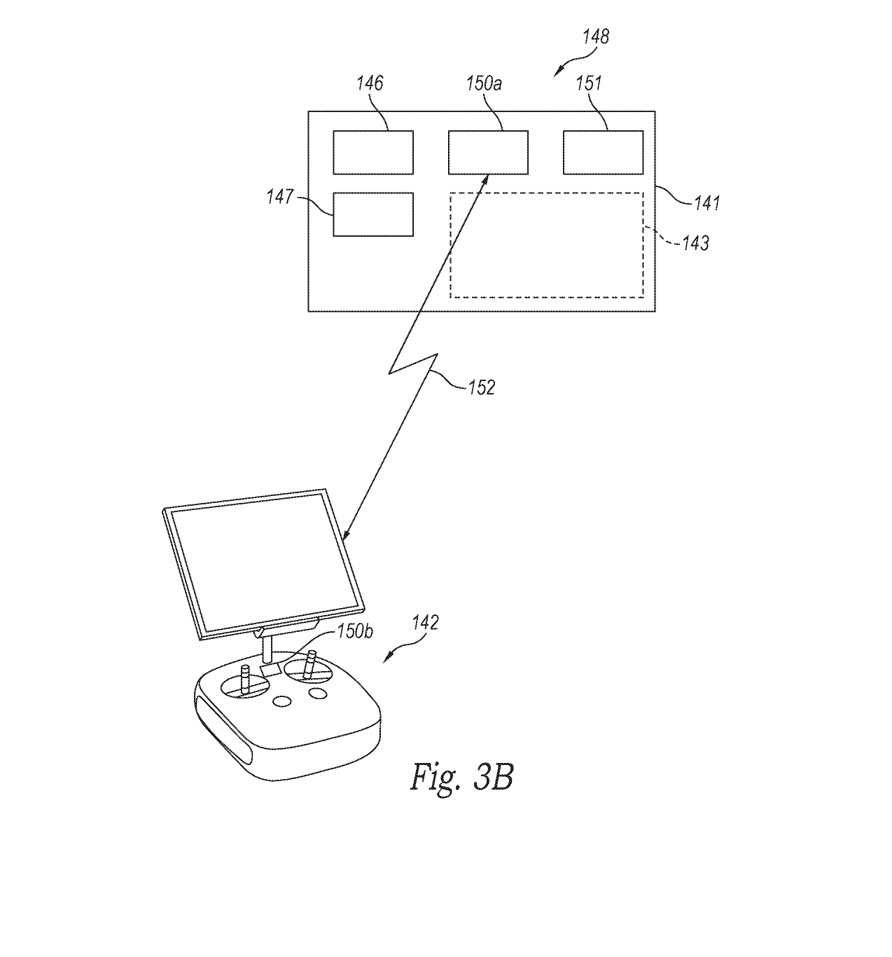

In FIG. 4, the first spherical motor 120a has tilted relative to the airframe 110 so that the corresponding first propeller 163a and a corresponding first thrust axis Ta are tilted relative to the orientation shown in FIG. 3A. The second spherical motor 120b tilts the second propeller 163b in the same direction to produce a tilted second thrust axis Tb. With both spherical motors 120a, 120b tilted as shown in FIG. 4, the UAV 100 travels from left to right, as indicated by arrow D. The airframe 110 itself is not tilted in order to achieve this motion. Accordingly, the payload 130, e.g., the imaging device 131, need not tilt or otherwise change orientation in order to accommodate a change in orientation of the airframe 110. This is unlike the operation of a conventional UAV, which typically tilts in order to change the axis along which it flies, which in turn requires the imaging device 131 to tilt in the opposite direction in order to maintain the orientation of the image it captures.

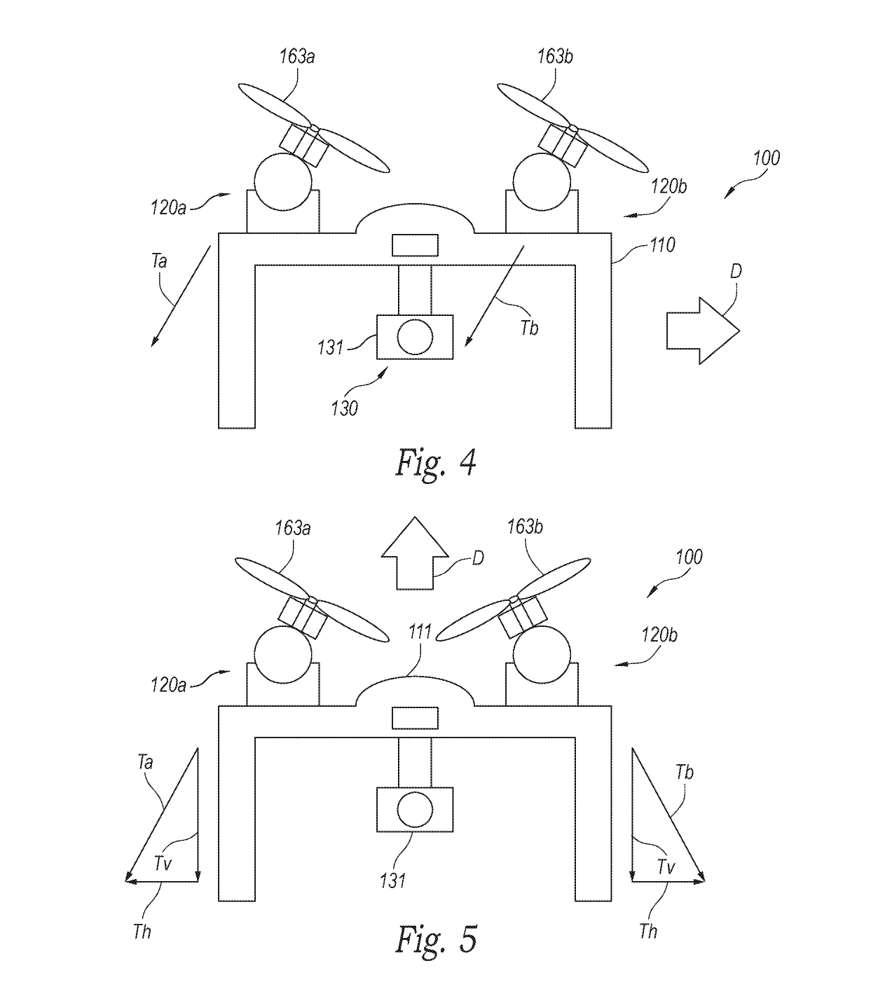

In FIG. 5, the first and second spherical motors 120a, 120b have tilted in opposite directions so that the corresponding thrust axes Ta, Tb point away from the central portion 111. The horizontal components Th of each thrust vector Ta, Tb cancel each other out, and the vertical components Tv are additive, resulting a vertical direction of travel, as indicated by arrow D. Because the thrust axes Ta, Tb are directed outwardly from the airframe 110, the air flow propelled by the corresponding propellers 163a, 163b does not impinge on the airframe 110, or impinges less than in a conventional arrangement. As a result, the airframe 110 is expected to be more stable than conventional airframes, thus improving the quality of images produced by the imaging device 131.

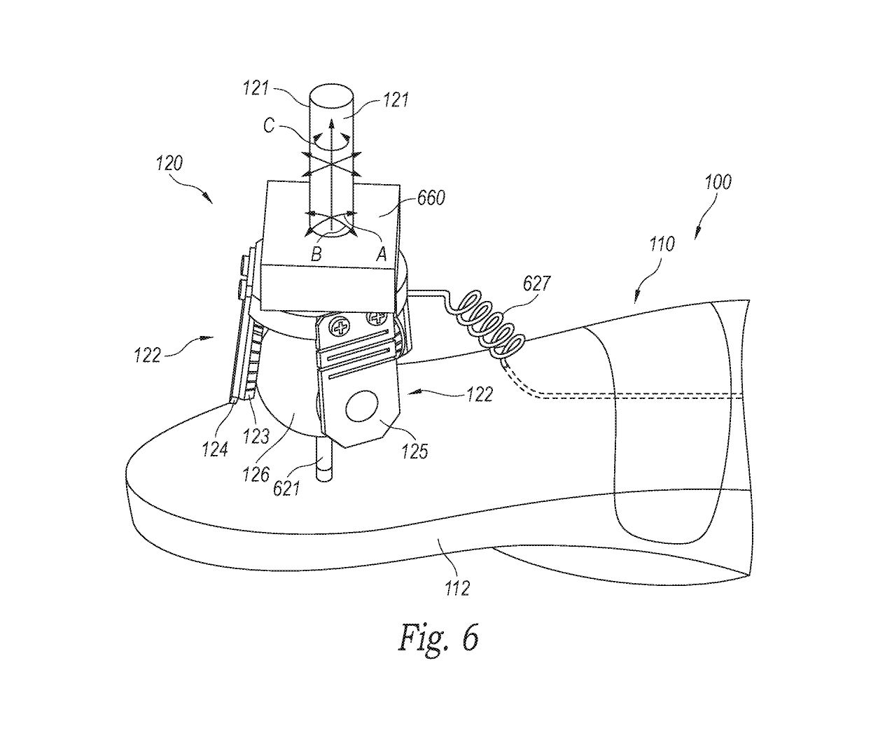

In an embodiment described above with reference to FIG. 2, the stators 122 have a fixed position relative to the airframe 110, and the rotor 126 rotates relative to the stators 122. In another embodiment, shown in FIG. 6, these components can have the opposite configuration. For example, the rotor 126 can be attached to the outer portion 112 of the airframe 110 via a mounting element 621, so as to have a fixed position relative to the airframe 110. The stators 122 carry a propeller motor 660 and, when activated, rotate relative to the fixed rotor 126 to tilt the propeller shaft 121 as indicated by arrows A and B. The propeller motor 660 can spin the propeller shaft 121 as indicated by arrow C. In this embodiment, a signal/power link (e.g., a flexible cable) 627 provides power to the stators 122, and the propeller motor 660. A similar arrangement can be used to provide power to the propeller motor 160 shown in FIG. 2.

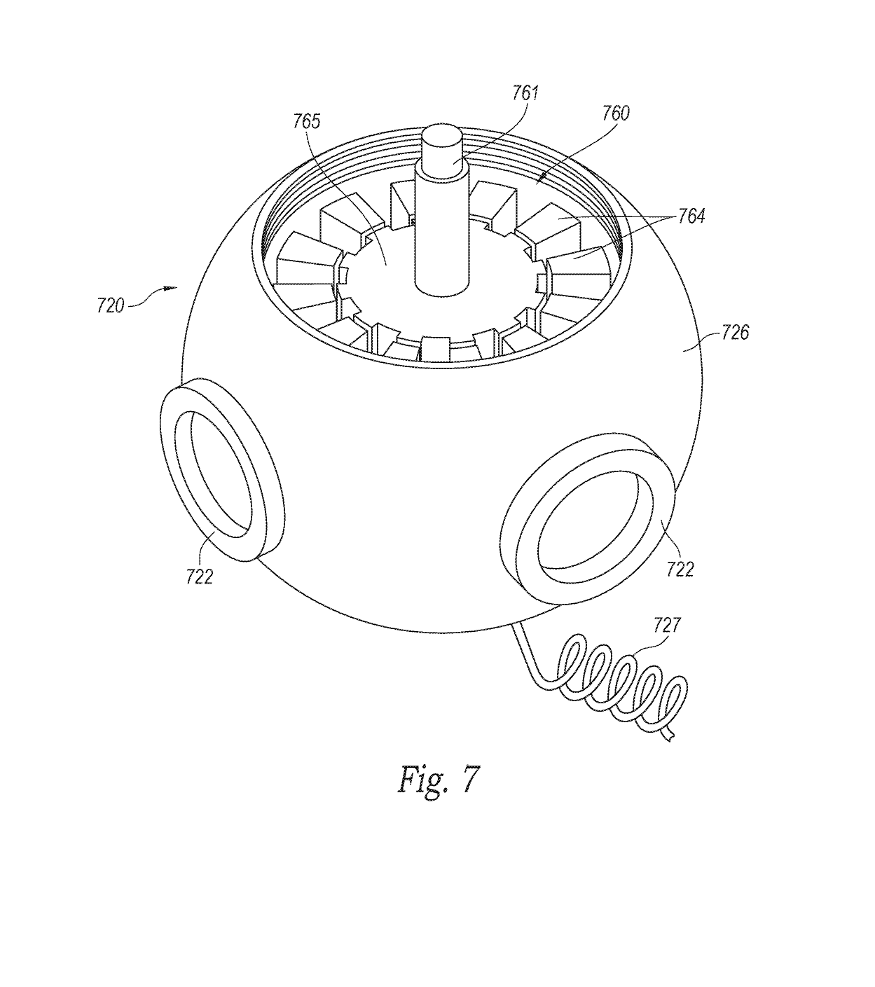

FIG. 7 is a schematic illustration of a spherical motor 720 carrying a corresponding propeller motor 760 that is at least partially integrated with a corresponding rotor 726. The rotor 726 is supported and rotated by corresponding stators 722, two of which are visible in FIG. 7. The propeller motor 760 includes multiple propeller motor stators 764 positioned around a corresponding propeller motor rotor 765 to rotate the corresponding propeller shaft 761. Power for the propeller motor stators 764 is provided by a signal/power link 727 that connects to the rotor 726, and is sufficiently flexible to allow the rotor 726 to freely tilt the propeller shaft 761 during normal operations. In a particular embodiment, the signal/communication link 727 can include a cable with sufficient flexibility and strain relief features. In another embodiment, the signal/communication link 727 can include an arrangement of slip rings to allow unlimited motion of the rotor 726 relative to the stators 722.

FIG. 8 is a flow diagram illustrating a representative process 880 for controlling the flight of a UAV in accordance with representative embodiments of the present technology. The process can include receiving a request to change a travel direction of the UAV (block 881). In response to the request, the process can further include directing at least one of a plurality of spherical motors to tilt a corresponding propeller (block 882). This process in turn can include directing the propellers to tilt without performing one or more of the following functions: (a) directing the airframe to tilt (block 883), (b) changing the orientation of the imaging device (block 884) or (c) causing the imaging device to image (e.g., capture an image of) the airframe 885. Depending upon the nature of the request for change in travel direction, two propellers can be tilted in opposite directions (block 886) e.g., for a lateral motion, or the two propellers can be tilted in the same direction (block 887) e.g., for vertical motion. In any of these embodiments, the thrust axis can be tilted away from the airframe (block 888) to reduce the degree to which the propeller “wash” impinges on the airframe.

One feature of several of the embodiments described above is that the spherical motors can tilt the corresponding propellers they carry relative to the airframe. An advantage of this arrangement is that the airframe itself need not tilt in order to change direction. As a result, the orientation of the imaging device or other sensor carried by the airframe need not be changed to compensate for a change in orientation of the airframe. This in turn is expected to produce more consistent and stable data from the imagining device or other sensor.

Another expected advantage of at least some of the foregoing embodiments is that the tilted propellers are less likely to direct air to impinge on the airframe. Accordingly, the position of the airframe in space is expected to be more stable than conventional arrangements, thus producing more stable and consistent data from the imaging device or other sensor.

Yet another expected advantage of at least some of the foregoing embodiments is that the functions provided by the spherical motors can reduce or eliminate the need for functions provided by the gimbal 115 (FIG. 1). In particular, the gimbal need not accommodate the tilting motion of the airframe (typical for conventional UAVs) and so can be made lighter, less responsive, or both. The gimbal may still be present as part of the UAV 100, for example, to allow the imaging device 131 to pan or otherwise scan the environment it images. In addition to or in lieu of the foregoing advantages, the reduced impact of propeller downwash on the airframe 110 can reduce the need for the gimbal to counteract jitters or other motion that such downwash may create. This in turn can reduce the design requirements placed on the gimbal and can accordingly reduce the cost of the gimbal, increase the life of the gimbal, or both.

From the foregoing, it will be appreciated that specific embodiments of the technology have been described herein for purposes of illustration, but that various modifications may be made without deviating from the technology. For example, representative spherical motors were described above in the context of ultrasonic motors. In other embodiments, other types of spherical motors can be used instead. In representative embodiments, the propeller motor can include a brushless direct current (BLDC) motor, and other embodiments can include other suitable motors. While the payload carried by the UAV in several embodiments include a camera, in other embodiments the payload can include other sensors or other suitable devices. In representative embodiments described above, an individual spherical motor rotor carries a single propeller shaft. In other embodiments, the spherical motor rotor can carry multiple (e.g., counter-rotating) propeller shafts and propellers.

Certain aspects of the technology described in the context of particular embodiments may be combined or eliminated in other embodiments. For example, one or more of the spherical motors and corresponding propellers shown in FIG. 1 can be eliminated in other embodiments. Not all the propellers carried by a UAV need to be controlled by a spherical motor. In some embodiments, one or more propellers can have a fixed rotation axis, or can be controlled by a device other than a spherical motor. In still further embodiments, the propeller motor can be eliminated, e.g., where the propeller shaft is connected directly to the spherical motor rotor. Further, while advantages associated with certain embodiments of the technology have been described in the context of those embodiments, other embodiments may also exhibit such advantages, and not all embodiments need necessarily exhibit such advantages to fall with within the scope of the present technology. Accordingly, the present disclosure and associated technology can encompass other embodiments not expressly shown or described herein.

To the extent any materials incorporated herein conflict with the present disclosure, the present disclosure controls.

At least a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

I/We claim:

1. An unmanned aerial vehicle (UAV) apparatus, comprising:
an airframe;
a plurality of spherical motors carried by the airframe; and
a plurality of rotatable propellers each being carried by one of the spherical motors.

2. The apparatus of claim 1, wherein at least one of the spherical motors includes a plurality of stators carrying a rotor.

3. The apparatus of claim 2, wherein the plurality of stators carry a part of the rotor.

4. The apparatus of claim 3, wherein the plurality of stators include a piezoelectric member.

5. The apparatus of claim 1, wherein at least one of the spherical motors includes an ultrasonic spherical motor.

6. The apparatus of claim 5, wherein the ultrasonic spherical motor includes:
a plurality of stators having fixed positions relative to the airframe; and
a rotor carrying one of the rotatable propellers, the rotor being rotatable relative to the plurality of stators.

7. The apparatus of claim 6, wherein:
the rotor includes a propeller shaft having a shaft axis and carrying the one of the rotatable propellers; and
rotation of the rotor about the shaft axis rotates the one of the rotatable propellers about the shaft axis.

8. The apparatus of claim 6, wherein:
the rotor carries an electric motor, the electric motor having a propeller shaft carrying the one of the rotatable propellers and being rotatable about a shaft axis; and
activation of the electric motor rotates the propeller shaft and the one of the rotatable propellers about the shaft axis.

9. The apparatus of claim 5, wherein the ultrasonic spherical motor includes:
a rotor having a fixed position relative to the airframe; and
a plurality of stators carrying one of the rotatable propellers, the plurality of stators being rotatable as a unit relative to the rotor.

10. The apparatus of claim 1, wherein the airframe includes:
a central portion; and
at least three outer portions positioned outwardly from the central portion.

11. The apparatus of claim 10, wherein each of the at least three outer portions carries one of the rotatable propellers.

12. The apparatus of claim 10, wherein the at least three outer portions include at least three arms, at least a portion of one of the at least three arms is separated from other ones of the at least three arms neighboring the one of the at least three arms.

13. The apparatus of claim 1, further comprising a controller programmed with instructions that, when executed, cause the controller to:
receive a request to change a direction of travel of the airframe; and
in response to the request, direct at least one of the plurality of spherical motors to tilt at least one of the rotatable propellers corresponding to the at least one of the plurality of spherical motors.

14. The apparatus of claim 13, wherein the instructions, when executed, cause the controller to direct the at least one of the spherical motors to tilt the at least one of the rotatable propellers without directing the airframe to tilt.

15. The apparatus of claim 13, wherein directing the at least one of the plurality of spherical motors to tilt the at least one of the rotatable propellers includes:
directing a first one of the rotatable propellers to tilt in a first direction, and
directing a second one of the rotatable propellers to tilt in a second direction opposite the first direction.

16. The apparatus of claim 13, further comprising:
an imaging device carried by the airframe;
wherein the instructions, when executed, cause the controller to direct the at least one of the spherical motors to tilt the at least one of the rotatable propellers without changing an orientation of the imaging device.

17. The apparatus of claim 16, wherein directing the at least one of the spherical motors includes directing the at least one of the spherical motors to tilt without causing the imaging device to image the airframe.

18. The apparatus of claim 13, wherein directing the at least one of the spherical motors includes directing the at least one of the spherical motors to tilt a thrust axis of the at least one of the rotatable propellers outwardly away from the airframe.

19. The apparatus of claim 13,
wherein the controller is a first controller carried by the airframe and having a first wireless communication device;
the apparatus further comprising a second controller that is remote to the first controller, the second controller having a second wireless communication device configured to communicate wirelessly with the first wireless communication device.

20. The apparatus of claim 1,
wherein:
the airframe includes at least four arms;
the plurality of spherical motors include four ultrasonic spherical motors, each carried by a corresponding one of the arms, wherein each of the spherical motors includes:
a plurality of stators having fixed positions relative to the corresponding one of the arms;
a rotor in contact with the stators and being rotatable relative to the corresponding one of the arms about at least a first axis and a second axis intersecting with the first axis; and
a propeller shaft carried by the rotor and being rotatable relative to the corresponding one of the arms about a third axis intersecting with the first and second axes; and
the plurality of rotatable propellers include four propellers, each carried by the propeller shaft of a corresponding one of the spherical motors;
the apparatus further comprising:
a controller programmed with instructions that, when executed, cause the controller to:
receive a request to change a direction of travel of the airframe; and
in response to the request, direct at least one of the four ultrasonic spherical motors to tilt a corresponding one of the propellers.
